(19) United States
(12) Patent Application Publication
(10) Pub. No.: US 2026/0328356 A1
(43) Pub. Date: Oct. 22, 2026

(54) HIGH BEAM MODULE FOR A MOTOR VEHICLE, HAVING AN UPWARDLY DIRECTED LIGHT SOURCE

(71) Applicant: VALEO VISION, Bobigny (FR)

(72) Inventors: Sylvain GIRAUD, Bobigny (FR); Lu BAI, BOBIGNY (FR)

(73) Assignee: VALEO VISION, Bobigny (FR)

(21) Appl. No.: 19/108,787

(22) PCT Filed: Sep. 6, 2023
(86) PCT No.: PCT/EP2023/074488

§ 371 Date: Mar. 5, 2025

(30) Foreign Application Priority Data
Sep. 6, 2022 (FR) FR2208905

(51) Int. Cl. F21S 41/32; F21S 41/255

(52) U.S. Cl. CPC F21S 41/321; F21S 41/255

(57) ABSTRACT

The invention relates to a lighting module including at least one light source that is able to emit light rays upwards, a collector having at least one reflective surface configured to collect and reflect the light rays emitted by the at least one light source as a light beam reflected along the optical axis, and a projection lens for projecting the reflected light beam as a projected light beam. The at least one reflective surface is configured such that the reflected light beam illuminates an entry face of the projection optical unit as far as an upper edge and/or a lower edge of the entry face.

### TECHNICAL FIELD

The invention relates to the technical field of lighting, more particularly automotive lighting.

### BACKGROUND OF THE INVENTION

Published patent document WO 2020/025171 A1 discloses an automotive lighting module comprising, essentially, an upwardly illuminating LED luminous source, a collector with a reflective surface having an elliptical profile configured to collect and reflect the light rays emitted by the luminous source toward a projection lens configured to image the reflective surface illuminated by the luminous source. To this end, the projection lens comprises a focal point located on or near the reflective surface, preferably near a rear edge of the reflective surface, in such a way as to sharply image the rear edge thus forming an upper cutoff. The lighting beam thus produced makes it possible to perform a low-beam type lighting function.

Published patent document FR 3 093 789 A1 discloses a double lighting module comprising a first lighting module according to the principle of the aforementioned document WO 2020/025171 A1 and a second lighting module also according to the same principle but opposite the first lighting module. The luminous source of the second lighting module therefore illuminates downward, the projection lens then imaging a reflective surface that is illuminated from the opposite direction compared to the first lighting module thus producing a lighting beam with a lower horizontal cutoff that supplements the lighting beam with an upper horizontal cutoff from the first lighting module to create a lighting function of the “high-beam” type. This combination of lighting modules is advantageous for producing the two, low-beam and high-beam, lighting functions but may have the disadvantage of vertical bulkiness caused by the superposition, in this instance opposite one another, of the two lighting modules.

### SUMMARY OF THE INVENTION

The aim of the invention is to mitigate at least one drawback of the abovementioned prior art. More specifically, the aim of the invention is to propose a lighting module able to produce a lighting beam that is compatible with producing a lighting function that has no upper cutoff, and that is vertically compact.

The invention relates to a lighting module comprising:
an optical axis;
at least one luminous source that is able to emit light rays along a main illumination axis that is directed upward when the lighting module is in an operational position;
a collector with at least one reflective surface configured to collect and reflect the light rays emitted by the at least one luminous source as a light beam reflected along the optical axis ;
a projection optic projecting the reflected light beam as a projected light beam; notable in that the at least one reflective surface is configured so that the reflected light beam illuminates an entry face of said projection optic as far as an upper edge and/or a lower edge of said entry face; and the projection optic comprises a focal point situated, along the optical axis, to the rear of the at least one reflective surface.

These measures are configured so that the at least one reflective surface illuminated by the light rays is imaged to a lesser extent horizontally than it is vertically. The invention thus exploits this special feature by illuminating the entry face of the projection optic as far as the upper edge and/or as far as the lower edge of the entry face of the projection optic. Also, the fact that the focal point of the projection lens lies to the rear of the collector enables the at least one illuminated reflective surface to be imaged less sharply, thereby vertically redistributing the light rays so that the light rays coming from the front and rear zones of the at least one reflective surface become vertically closer together.

Advantageously, the projection optic is a projection lens. Alternatively, the projection optic may be formed by at least one mirror.

According to one advantageous embodiment of the invention, the light rays reflected by a front part of the at least one reflective surface along the optical axis reach a zone on the entry face that is adjacent to the upper edge and/or the light rays reflected by a rear part of the at least one reflective surface along the optical axis reach a zone on the entry face that is adjacent to the lower edge.

According to one advantageous embodiment of the invention, the at least one reflective surface has a hyperbolic profile in a vertical plane defined by the optical axis and the main illumination axis, with a first focal point situated at the at least one luminous source and a second focal point, which is a virtual focal point, situated to the rear of the collector. The reflective surface may then have a hyperbolic profile in a horizontal plane extending perpendicular to the main illumination axis. Alternatively, the reflective surface may have an elliptical profile in a horizontal plane extending perpendicular to the main illumination axis, allowing the reflected light beam to be made to converge in the horizontal plane, whereas the reflected light beam diverges in the vertical plane.

According to one advantageous embodiment of the invention, the second focal point of the at least one reflective surface is situated at a distance, along the optical axis, from the first focal point of the at least one reflective surface, that is greater than or equal to a distance, along said optical axis, between said first focal point and the entry face of the projection optic.

According to one advantageous embodiment of the invention, the at least one reflective surface has an elliptical profile, with a first focal point situated at the at least one luminous source and a second focal point situated in front of the entry face of the projection optic.

According to one advantageous embodiment of the invention, the second focal point of the at least one reflective surface situated in front of the projection optic forms a curve that is oriented vertically when the lighting module is in an operational position.

According to one advantageous embodiment of the invention, the projection optic has a vertical optical power and a horizontal optical power that is zero or that is less than said vertical optical power. Advantageously, the horizontal optical power is less than 50% of the vertical optical power.

Advantageously, the projected light beam forms, notably in part, an automotive lighting beam of the high-beam type.

The invention also relates to a lighting device for a motor vehicle, comprising a first lighting module configured to project a first beam of light with an upper horizontal cutoff, for example for a function of the low-beam type; and a second lighting module configured to project a second beam of light which, with the first beam of light, at least partially forms a lighting function of the high-beam type; notable in that the second module is one in accordance with the invention.

According to one advantageous embodiment of the invention, the first lighting module comprises at least one luminous source arranged on a mounting plate and a collector having at least one reflective surface configured to collect and reflect light rays emitted by said at least one luminous source as a first reflected light beam; the at least one luminous source of the second lighting module being arranged on the mounting plate and directed in the same direction as the at least one source of the first lighting module.

The measures of the invention are advantageous in that they make it possible to produce a lighting module that is able to produce a light beam which, together with one or more light beam(s) with an upper horizontal cutoff, form a lighting function that has no upper horizontal cutoff, particularly a regulation automotive lighting function of the “high-beam” type, which is vertically compact particularly when combined with other lighting modules that form the light beam or beams having an upper horizontal cutoff.

### BRIEF DESCRIPTION OF DRAWINGS

FIG. 1 is a schematic depiction, in cross section, of a lighting module according to the prior art;

FIG. 2 depicts the image of the light beam produced by the lighting module of FIG. 1;

FIG. 3 is a schematic depiction, in cross section, of a lighting module according to a first embodiment of the invention;

FIG. 4 depicts the image of the light beam produced by the lighting module of FIG. 3;

FIG. 5 is a schematic depiction, in cross section, of a lighting module according to a second embodiment of the invention;

FIG. 6 depicts the image of the light beam produced by the lighting module of FIG. 5; and

FIG. 7 is a schematic depiction, in perspective, of a lighting module according to the invention.

### DETAILED DESCRIPTION OF THE INVENTION

In the description below, the concepts of relative position and orientation, as expressed by the terms “top”, “bottom”, “front”, “rear”, “upper” and “lower”, are to be understood when the lighting device or module is in the operational position as illustrated in the figures.

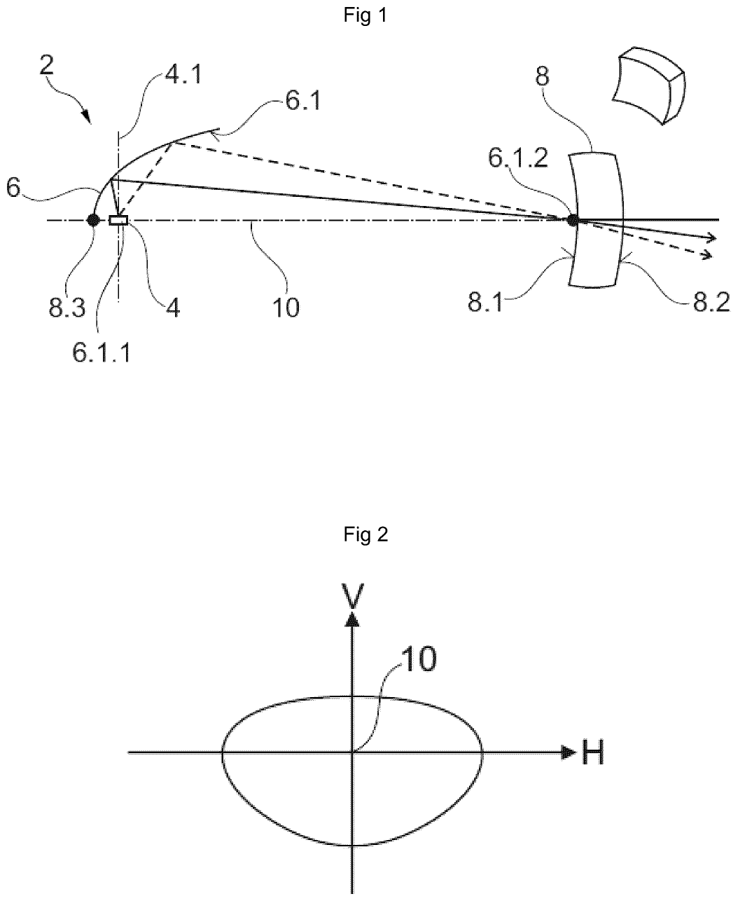

FIG. 1 and FIG. 2 illustrate a lighting module according to the prior art.

FIG. 1 is a schematic depiction, in cross section, of a lighting module according to the prior art. The lighting module 2 comprises a luminous source 4, of the LED type having light-emitting diodes, illuminating a space delimited by a plane corresponding to the spread of the luminous source, in this instance the horizontal spread, and directed upward in a main direction of lighting 4.1 that is perpendicular to said plane. The lighting module 2 also comprises a collector 6 provided with a reflective surface 6.1 forming a cavity able to collect and to reflect the light rays emitted directly by the luminous source 4. The lighting module 2 also comprises a projection lens 8 perpendicular to the optical axis 10 of said lighting module. The luminous source 4 is aligned with the optical axis 10, for the sake of simplification, it being always understood that it could lie some distance from said optical axis 10. The reflective surface 6.1 has an elliptical profile exhibiting symmetry of revolution, over 180° or less, about the optical axis 10, with a first focal point 6.1.1 situated at the luminous source 4 and a second focal point 6.1.2 situated on the entry face 8.1, opposite to the exit face 8.2, of the projection lens 8. The latter comprises a focal point 8.3 situated at the intersection of the optical axis 10 with the reflective surface 6.1. The projection lens 8 has a vergence, or optical power, corresponding to the inverse of the focal length, namely the distance between the projection lens 8 and the focal point 8.3, in all directions perpendicular to the optical axis 10, so that the part of the reflective surface 6.1 situated at the focal point 8.3 can be fully imaged. The rest of the reflective surface 6.1 is also imaged, but with a lesser degree of sharpness according to its distance away from the focal point 8.3. To this end, the projection lens 8 has entry faces 8.1 and 8.2 that have curvatures in horizontal and vertical planes.

FIG. 2 graphically illustrates the image of the light beam projected by the lighting module of FIG. 1, in the form of an outline of equal luminous brightness, commonly referred to as an iso-lux curve, in an H-V orthonormal frame of reference where H corresponds to a horizontal axis and V to a vertical axis. The intersection of the axes H and V corresponds to the optical axis 10. The luminous image has an appearance that in reality corresponds to the reflective surface 6.1 illuminated by the luminous source 4 (FIG. 1), but inverted. The central upper part of the luminous image corresponds to that part of the reflective surface 6.1 that is situated at the focal point 8.3 (FIG. 1) and thus forms a horizontal cutoff, whereas the lower part of the luminous image corresponds to that part of the reflective surface 6.1 that is situated at a front edge of said reflective surface and generally does not form a sharp cut-off.

The luminous image illustrated in FIG. 2, because of its shape and its differences in sharpness, is not suitable for completing a luminous image with an upper horizontal cutoff corresponding to a lighting function of the “low-beam” type with a view to forming a lighting function of the “high-beam” type.

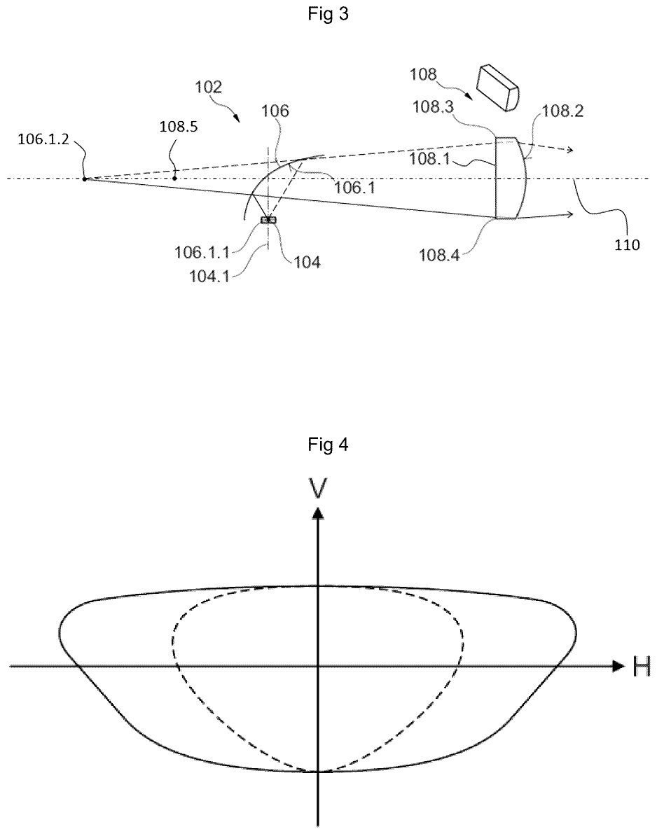

FIG. 3 and FIG. 4 illustrate a lighting module according to a first embodiment of the invention.

FIG. 3 is a schematic view, in cross section, of the lighting module according to the first embodiment of the invention. The reference numerals in the lighting module of FIG. 1 are used to denote those elements that are identical or corresponding, although these numerals are increased by 100. Reference is moreover made to the description of these elements with reference to FIG. 1 and FIG. 2.

The lighting module 102 of FIG. 3 differs from the lighting module 2 of FIG. 1 essentially in that the reflective surface 106.1 of the collector 106 has a hyperbolic profile in a vertical plane defined by the optical axis 110 and the main illumination axis 104. The reflective surface 106.1 then has a first focal point 106.1.1 situated at the luminous source 104 and a second focal point 106.1.2, which is a virtual focal point, situated to the rear of the reflective surface 106.1 in question and therefore also to the rear of the collector 106. The effect of this configuration of the reflective surface 106.1 is that it produces a reflected light beam that is divergent, notably in the vertical plane, and able to illuminate the entry face 108.1 of the projection lens 8 as far as the upper edge 108.3 and/or as far as the lower edge 108.4 of said projection lens 108. In other words, the rays reflected by the front part of the reflective surface 106.1 reach a zone on the entry face 108.1 that is adjacent to the upper edge 108.3 and, similarly, the rays reflected by the rear part of the reflective surface 106.1 reach a zone on the entry face 108.1 that is adjacent to the lower edge 108.4. The zone on the entry face 108.1 that is adjacent to the upper edge 108.3 advantageously comprises said upper edge 108.3. Similarly, the zone on the entry face 108.1 that is adjacent to the lower edge 108.4 advantageously comprises said lower edge 108.4.

An upper part of the reflected light beam may be lost and therefore cut off by the upper edge 108.3 of said projection lens 108. This cutting-off of the upper part of the reflected light beam results in a lower cutoff of the projected light beam, bearing in mind the inversion caused by the projection lens 108.

It will be noted that the reflective surface 106.1 may advantageously have an elliptical profile in a horizontal plane extending perpendicular to the main illumination axis. Alternatively, the reflective surface 106.1 may have a hyperbolic profile in the horizontal plane.

The distance, along the optical axis 110, between the first focal point 106.1.1 and the second focal point 106.1.2, which is a virtual focal point, is advantageously greater than or equal to a distance, along the optical axis 110, between the first focal point 106.1.1 concerned and the entry face 108.1 of the projection lens 108. That makes it possible to limit the divergence of the reflected light beam and thus limit the size, particularly vertically, of the projection lens 108.

The lighting module 102 of FIG. 3 also differs from the lighting module 2 of FIG. 1 in that the focal point 108.5 of the projection lens 108 is situated to the rear of the collector 106 and of the reflective surface 106.1. This configuration has the effect of defocusing the reflective surface 106.1 illuminated by the luminous source 104, the rear and front edges of said reflective surface 106.1 then being imaged in such a way that they appear even closer to one another, causing an essentially vertical redistribution of light that consists in bringing the light rays originating from the front and rear zones of the reflective surface 106.1 closer together vertically.

The lighting module 102 of FIG. 3 differs from the lighting module 2 of FIG. 1 also in that the projection lens 108 comprises an entry face 108.1 that is flat and an exit face 108.2 that has a vertical curvature only, i.e. that has no horizontal curvature. The projection lens 108 illustrated thus has a zero horizontal optical power. This then is a simplified configuration aimed at improving the clarity of the description of the invention. It must be understood that the projection lens 108 may have other geometric characteristics while still having a vertical optical power associated with its focal point 108.5 situated to the rear of the reflective surface 106.1 and a horizontal optical power that is zero or less than the vertical optical power in question. In the event of a horizontal optical power that is non-zero, the projection lens 108 then has a second focal point, referred to as horizontal focal point, situated even further to the rear along the optical axis 110 from the focal point 108.5, meaning that the reflective surface 106.1 illuminated by the luminous source 104 will be only partially imaged horizontally or will be imperfectly imaged horizontally, likewise leading to a horizontal spread of the projected light beam produced by the lighting module 102. The horizontal optical power, whenever it is non-zero, is advantageously less than 50% of the vertical optical power.

FIG. 4 graphically illustrates the image of the light beam projected by the lighting module of FIG. 3, in the form of an outline of equal luminous brightness, commonly referred to as an iso-lux curve, in a similar way to FIG. 2.

The luminous image in question is illustrated by a continuous line whereas the luminous image of the light beam projected by the lighting module of FIG. 1 and illustrated in FIG. 2 is illustrated in the form of a broken line. It may be noted that the luminous image of the light beam produced by the lighting module 102 of FIG. 3 has a substantially greater horizontal spread than the luminous image of the light beam produced by the lighting module of FIG. 1, making it suitable for completing a light beam with an upper horizontal cutoff with a view to forming a light beam without a horizontal cutoff, such as for example a lighting function of the “high-beam” type.

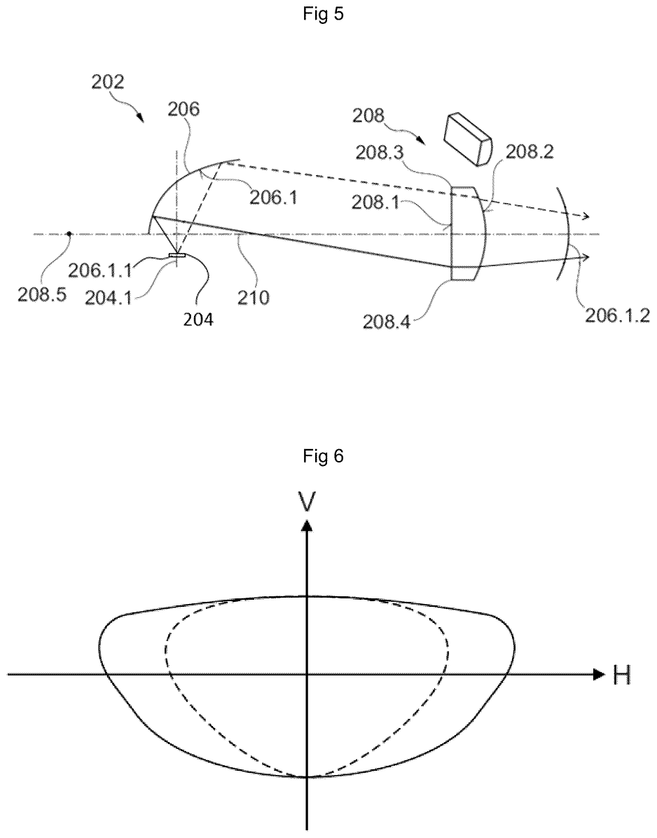

FIG. 5 and FIG. 6 illustrate a lighting module according to a second embodiment of the invention.

FIG. 5 is a schematic view, in cross section, of the lighting module according to the second embodiment of the invention. The reference numerals in the lighting module of FIG. 3 are used to denote those elements that are identical or corresponding, although these numerals are increased by 100. Reference is moreover made to the description of these elements with reference to FIG. 3 and FIG. 4, and to the description of these elements with reference to FIG. 1 and FIG. 2.

The lighting module 202 of FIG. 5 differs from the lighting module 102 of FIG. 3 essentially in that the reflective surface 206.1 of the collector 206 has an elliptical profile. The reflective surface 206.1 therefore has a first focal point 206.1.1 situated at the luminous source 204 and a second focal point, which is no longer a virtual focal point to the rear of the collector but which is formed by a vertical focal curve 206.1.2 situated in front of the projection lens 208, so that, with the light beam reflected by the reflective surface 206.1, it illuminates the entry face 208.1 upward as far as its upper edge 208.3 and downward as far as its lower edge 208.4, an upper part of said reflected light beam therefore being able to be lost and therefore cut off by the upper edge 208.3 in question. This cutting-off of the upper part of the reflected light beam results in a lower cutoff of the projected light beam, bearing in mind the inversion caused by the projection lens 208. Also, the vertical focal curve 206.1.2 in front of the projection lens 208 causes a reduction in the vertical spread of the projected light beam and causes illumination of a vertically spread part of the entry face 208.1 of the projection lens 208 that is favorable to a horizontal spreading of the projected light beam, as in the first and second embodiments.

In a similar way to the lighting module 102 in FIG. 3, the focal point 208.5 of the projection lens 208 is situated to the rear of the collector 206 and of the reflective surface 206.1, and the projection lens 208 has an entry face 208.1 that is flat and an exit face 208.2 that has a vertical curvature only, i.e. that has no horizontal curvature. The projection lens 208 illustrated thus has a zero horizontal optical power. These differences are similar to the differences between the lighting module 102 of FIG. 3 and the lighting module 2 of FIG. 1.

FIG. 6 graphically illustrates the image of the light beam projected by the lighting module of FIG. 5, in the form of an outline of equal luminous brightness, commonly referred to as an iso-lux curve, in a similar way to FIG. 2 and FIG. 4.

The luminous image in question is illustrated by a continuous line whereas the luminous image of the light beam projected by the lighting module of FIG. 1 and illustrated in FIG. 2 is illustrated in the form of a broken line. It may be noted that the luminous image of the light beam projected by the lighting module of FIG. 5 has the same vertical spread as the luminous image of the light beam projected by the lighting module of FIG. 1. Alternatively, the luminous image of the light beam projected by the lighting module of FIG. 5 could have less vertical spread than the luminous image of the light beam projected by the lighting module of FIG. 1, as a result of the lower cutoff. It may also be noted that the luminous image of the light beam projected by the lighting module of FIG. 5 has a slightly greater horizontal spread than the luminous image of the light beam projected by the lighting module of FIG. 1, because of the horizontal optical power being zero or less than the vertical optical power.

It should be noted that the cutting-off of the upper part of the reflected light beam is optional.

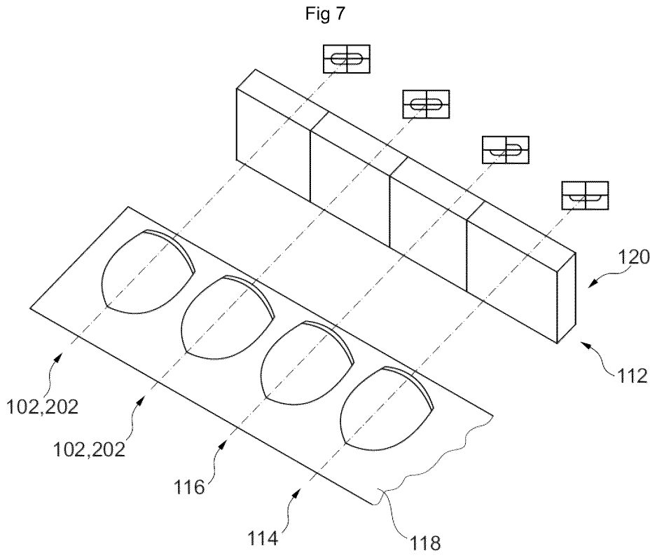

FIG. 7 illustrates, schematically and in perspective, a lighting device comprising a plurality of lighting modules at least one of which is in accordance with the invention.

The lighting device 112 comprises a first lighting module 114 similar or identical to the lighting module 2 illustrated in FIG. 1. Such a lighting module is then configured to produce a projected light beam with an upper horizontal cutoff that is preferably flat and known as a “flat” cutoff. The luminous image of such a light beam is illustrated graphically and schematically in an H-V orthonormal frame of reference, in a similar way to FIG. 2, FIG. 4, FIG. 6 and FIG. 8.

The lighting device 112 comprises at least a second lighting module according to the invention, in this instance such as one of the modules 102 and 202 described hereinabove. This or these second lighting module(s) are then configured so as to each produce a light beam projected without an upper horizontal cutoff, able to complete the light beam of the first lighting module 114 with a view to forming a lighting light beam with no upper horizontal cutoff, in this instance a regulation automotive lighting beam of the “high beam” type.

The lighting module 112 may also comprise a third lighting module 116, similar to the first lighting module 114, although different in that it is configured to project a narrow lighting light beam of which the upper horizontal cutoff is said to have a “kink” or be kinked. This light beam, combined with that of the first lighting module 114, is able to produce a regulation automotive lighting beam of the “low-beam” type for European territories. Certain regulations, notably those of the United States of America, do not require a kink in the horizontal cutoff, in which case the third lighting module can be dispensed with. However, it should be noted that the third lighting module may be configured to produce a light beam with a flat upper horizontal cutoff, similar to the first lighting module 114, to supplement the light beam of said first lighting module in order to produce the regulation automotive lighting beam of the “low-beam” type for territories that do not demand a kink.

It is advantageous to note that the luminous sources of each of the first, second and third lighting modules are arranged on a mounting plate 118, which is then common to them, and are all directed upward. The collectors of the lighting modules are then each oriented so that their opening faces downward and are advantageously supported by the mounting plate 118 or at the very least secured to the mounting plate 118. It is also conceivable, or even preferable, for the collectors of the various lighting modules to be formed integrally, as a single piece. The projection lens 120 of the lighting device may then be a juxtaposition of the projection lenses of the various lighting modules, these projection lenses then advantageously being able to be formed integrally, as a single piece.

The lighting device 112 of FIG. 7 thus has a limited vertical bulk, something that may be particularly advantageous for integrating it into the lines of present-day vehicle bodywork.

In general, namely notably in the case of the first and second embodiments, each lighting module may comprise a plurality of luminous sources arranged side-by-side, and a plurality of reflective surfaces, likewise arranged side-by-side, and advantageously formed on the collector. Also, the luminous source or sources are not necessarily situated precisely on the optical axis; indeed they may be situated below the optical axis. Also, when the focal point of the projection lens is situated to the rear of the reflective surface, it does not necessarily need to be situated on the optical axis and may indeed be situated some distance from said optical axis, for example above same. In other words, certain geometric simplifications have been made in the embodiments for the sake of simplifying the clarity of the description, it being appreciated that deviations from these geometric simplifications are conceivable within the scope of the invention.

Also, in general, the projection lens may be replaced by one or more projection mirrors. In that case, the mirror or at least one of the mirrors has a non-planar surface able to form and project the light beam.

What is claimed is:

1. A lighting module comprising:
an optical axis;
at least one luminous source that is able to emit light rays along a main illumination axis that is directed upward when the lighting module is in an operational position;
a collector with at least one reflective surface configured to collect and reflect the light rays emitted by the at least one luminous source as a light beam reflected along the optical axis;
a projection optic projecting the reflected light beam as a projected light beam; wherein
the at least one reflective surface is configured so that the reflected light beam illuminates an entry face of the projection optic as far as an upper edge and/or a lower edge of the entry face,
and the projection optic includes a focal point situated, along the optical axis, to the rear of the at least one reflective surface.

2. The lighting module as claimed in claim 1, wherein the light rays reflected by a front part of the at least one reflective surface along the optical axis reach a zone on the entry face that is adjacent to the upper edge and the light rays reflected by a rear part of the at least one reflective surface along the optical axis reach a zone on the entry face that is adjacent to the lower edge.

3. The lighting module as claimed in claim 1, wherein the at least one reflective surface has a hyperbolic profile in a vertical plane defined by the optical axis and the main illumination axis, with a first focal point situated at the at least one luminous source and a second focal point, which is a virtual focal point situated to the rear of the collector.

4. The lighting module as claimed in claim 3, wherein the second focal point of the at least one reflective surface is situated at a distance, along the optical axis, from the first focal point of the at least one reflective surface, that is greater than or equal to a distance, along the optical axis, between the first focal point and the entry face of the projection optic.

5. The lighting module as claimed in claim 1, wherein the at least one reflective surface has an elliptical profile, with a first focal point situated at the at least one luminous source and a second focal point situated in front of the projection optic.

6. The lighting module as claimed in claim 5, wherein the second focal point of the at least one reflective surface situated in front of the projection optic forms a curve that is oriented vertically when the lighting module is in an operational position.

7. The lighting module as claimed in claim 1, wherein the projection optic has a vertical optical power and a horizontal optical power that is zero or that is less than the vertical optical power.

8. A lighting device for an automotive vehicle, comprising:
a first lighting module configured to project a first beam of light with an upper horizontal cutoff, for example for a function of the low-beam type; and
a second lighting module configured to project a second beam of light which, with the first beam of light, at least partially forms a lighting function of the high-beam type;
wherein the second module includes an optical axis, at least one luminous source that is able to emit light rays along a main illumination axis that is directed upward when the lighting module is in an operational position, a collector with at least one reflective surface configured to collect and reflect the light rays emitted by the at least one luminous source as a light beam reflected along the optical axis, a projection optic projecting the reflected light beam as a projected light beam, wherein the at least one reflective surface is configured so that the reflected light beam illuminates an entry face of the projection optic as far as an upper edge and/or a lower edge of the entry face, and the projection optic includes a focal point situated, along the optical axis, to the rear of the at least one reflective surface.

9. The lighting device as claimed in claim 8, wherein the first lighting module includes at least one luminous source arranged on a mounting plate and a collector having at least one reflective surface configured to collect and reflect light rays emitted by the at least one luminous source as a first reflected beam; the at least one luminous source of the second lighting module being arranged on the mounting plate and directed in the same direction as the at least one source of the first lighting module.
